(19) United States
(12) Patent Application Publication
(10) Pub. No.: US 2024/0322331 A1
(43) Pub. Date: Sep. 26, 2024

(54) BATTERY PACK

(71) Applicant: HONDA MOTOR CO.,LTD., Tokyo (JP)

(72) Inventors: Yu IEMURA, Saitama (JP); Ken Yasui, Saitama (JP); Satoru Kawabe, Saitama (JP); Masaaki Tatsuwaki, Saitama (JP)

(73) Assignee: HONDA MOTOR CO., LTD., Tokyo (JP)

(21) Appl. No.: 18/588,036

(22) Filed: Feb. 27, 2024

(30) Foreign Application Priority Data
Mar. 24, 2023 (JP) 2023-048322

(51) Int. Cl. H01M 50/242; B60L 50/60; H01M 50/204; H01M 50/271

(52) U.S. Cl. CPC H01M 50/242; H01M 50/204; H01M 50/271; B60L 50/60; H01M 2220/20

(57) ABSTRACT

A battery pack is mounted on a vehicle. The battery pack has a battery, and a battery case accommodating the battery. The battery case includes a base plate on which the battery is placed, a frame member joined to an outer edge of the base plate, and a cover covering the battery and attached to the frame member via a sealing member. The frame member includes a protection region located on an inner side with respect to the sealing member, and a deformation region located on an outer side with respect to the sealing member. The base plate is joined to the frame member in the protection region, and a tip end of the base plate extends to at least the deformation region when viewed in a cross section.

### CROSS-REFERENCE TO RELATED APPLICATIONS

This application is based on and claims priority under 35 USC 119 from Japanese Patent Application No. 2023-048322 filed on Mar. 24, 2023, the entire content of which is incorporated herein by reference.

### TECHNICAL FIELD

The present disclosure relates to a battery pack to be mounted on a vehicle.

### BACKGROUND ART

In recent years, researches and developments have been conducted on a secondary battery (hereinafter, also referred to as a battery) that contributes to improvement in energy efficiency in order to allow more users to access affordable, reliable, sustainable, and advanced energy.

A large-capacity battery is mounted on a vehicle such as a battery type electric automobile, a hybrid vehicle, or a fuel cell vehicle. Since the battery mounted on such a vehicle is a high-voltage component, it is necessary to protect the battery from an impact. However, a large load may be input to the battery due to a vehicle collision or the like.

On the other hand, in a battery pack described in JP2022-081322A, a bottom wall of a tray on which a battery is mounted has a tray deformation region. When a side collision load is generated due to a side collision, collision energy is absorbed by a deformation of the tray deformation region.

In the structure described in JP2022-081322A, the collision energy can be absorbed by the tray deformation region formed on the bottom wall of the tray, but a side beam needs to be formed thick in order to protect a battery module by preventing a deformation of the side beam, and a weight of a battery case is increased accordingly.

### SUMMARY OF INVENTION

The present disclosure provides a battery pack capable of protecting a battery against a load input caused by a collision of a vehicle while reducing a weight.

An aspect of the present disclosure relates to a battery pack to be mounted on a vehicle, the battery pack including:
a battery; and
a battery case accommodating the battery,
in which the battery case includes:
   a base plate on which the battery is placed;
   a frame member joined to an outer edge of the base plate; and
   a cover covering the battery and attached to the frame member via a sealing member,
the frame member includes:
   a protection region located on an inner side with respect to the sealing member; and
   a deformation region located on an outer side with respect to the sealing member, and
the base plate is joined to the frame member in the protection region, and a tip end of the base plate extends to at least the deformation region when viewed in a cross section.

According to the present disclosure, it is possible to protect the battery against a load input caused by a collision of the vehicle while reducing a weight.

### BRIEF DESCRIPTION OF DRAWINGS

Exemplary embodiment(s) of the present invention will be described in detail based on the following figures, wherein:

FIG. 1 is a perspective view of a battery pack 1 and a vehicle V on which the battery pack 1 is mounted;

FIG. 2 is an exploded perspective view of the battery pack 1;

FIG. 3 is a plan view showing an internal structure of the battery pack 1;

FIG. 4 is a perspective view of a cross section taken along a line A-A of FIG. 3;

FIG. 5 is an enlarged view of a portion B in FIG. 4, showing a rear cross member 41 and a base plate 30;

FIG. 6 is a cross-sectional view of the rear cross member 41 and the base plate 30;

FIG. 7 is an enlarged view of a portion C in FIG. 4, showing a front cross member 42 and the base plate 30;

FIG. 8 is a cross-sectional view of the rear cross member 41 and the base plate 30 of a first modification;

FIG. 9 is a cross-sectional view of the rear cross member 41 and the base plate 30 of a second modification;

FIG. 10 is a cross-sectional view of the rear cross member 41 and the base plate 30 of a third modification;

FIG. 11 is a cross-sectional view of the rear cross member 41 and the base plate 30 of a fourth modification;

FIG. 12 is a cross-sectional view of the rear cross member 41 and the base plate 30 of a fifth modification;

FIG. 13 is a cross-sectional view of the rear cross member 41 and the base plate 30 of a sixth modification;

FIG. 14 is a cross-sectional view of the rear cross member 41 and the base plate 30 of a seventh modification; and

FIG. 15 is a cross-sectional view of the rear cross member 41 and the base plate 30 of an eighth modification.

### DESCRIPTION OF EMBODIMENTS

Hereinafter, a battery pack according to an embodiment of the present disclosure will be described with reference to the accompanying drawings. The drawings are viewed from directions of reference numerals, and in the following description, directions such as front, rear, left, right, upper, and lower directions are described according to a direction viewed from a driver of a vehicle. In the drawings, a front side of the vehicle is denoted by Fr, a rear side is denoted by Rr, a left side is denoted by L, a right side is denoted by R, an upper side is denoted by U, and a lower side is denoted by D. Further, a left-right direction is also referred to as a vehicle width direction.

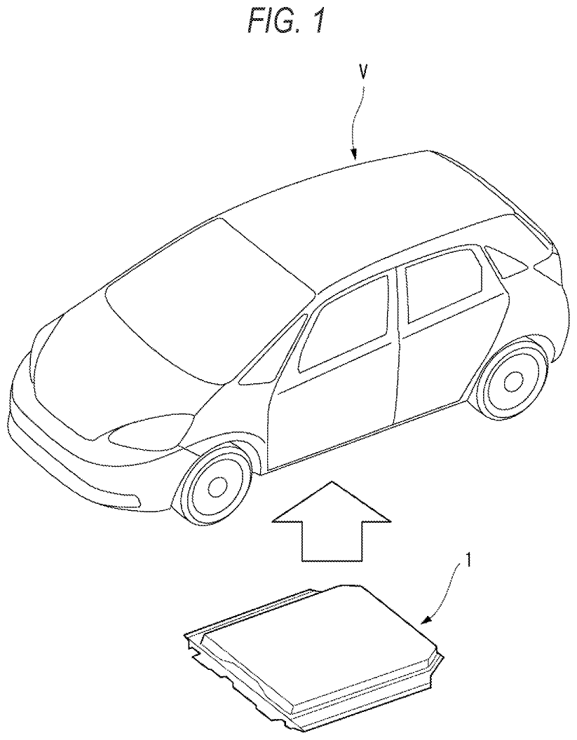

As shown in FIG. 1, a battery pack 1 according to an embodiment of the present disclosure is mounted on a vehicle V. The vehicle V is an electric vehicle such as a battery type electric automobile, a hybrid vehicle, or a fuel cell vehicle. The battery pack 1 is disposed below a floor panel of the vehicle V and attached to a vehicle body.

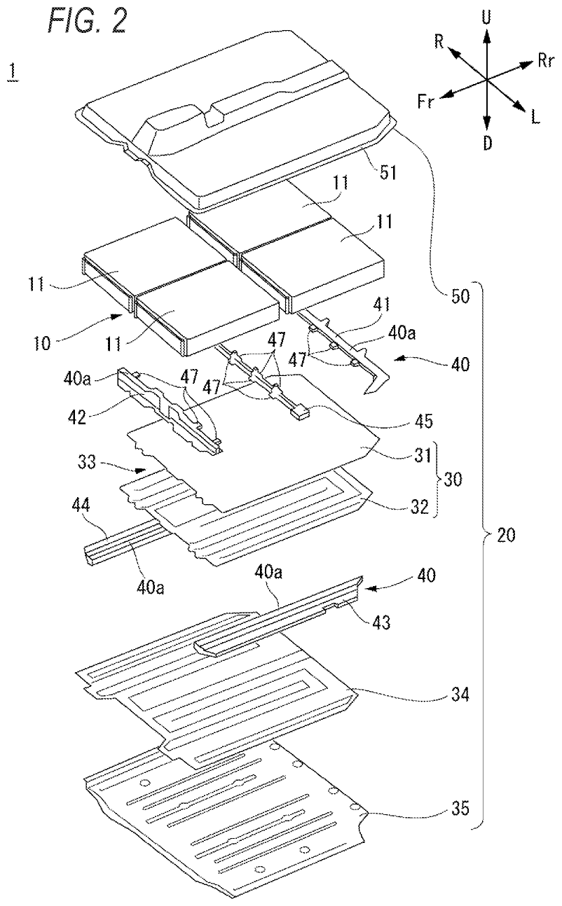

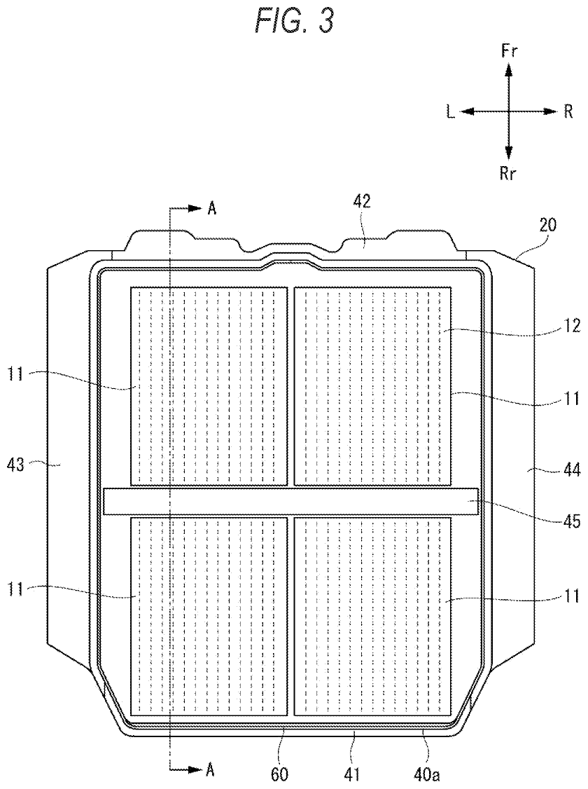

As shown in FIGS. 2 and 3, the battery pack 1 includes four battery modules 11 and a battery case 20 that accommodates the battery modules 11.

The four battery modules 11 are arranged in two rows in a front-rear direction and in two rows in a left-right direction. The four battery modules 11 are electrically connected to one another via an electrical connection member (for example, a bus bar) (not shown). The battery modules 11 store electric power to be supplied to a motor or the like serving as a drive source of the vehicle V. The number of battery modules 11 can be freely set, and an arrangement is also not particularly limited.

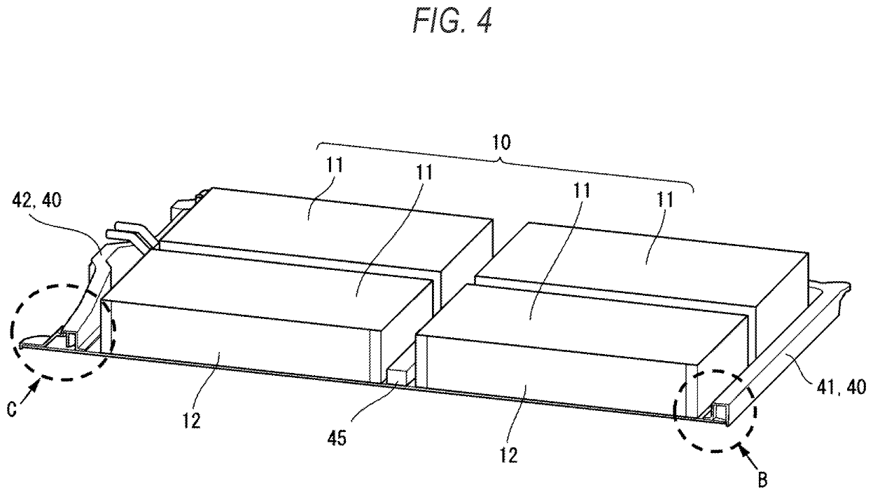

As shown in FIGS. 3 and 4, each battery module 11 includes a plurality of battery cells 12 stacked in a vehicle width direction. In FIG. 3, the plurality of battery cells 12 are each indicated by a broken line. Each battery cell 12 is, for example, a laminated cell. The laminated cell includes a positive electrode to which a positive electrode tab is connected, a negative electrode to which a negative electrode tab is connected, an electrolyte disposed between the positive electrode and the negative electrode, and a laminated film that accommodates the positive electrode, the negative electrode, and the electrolyte, and the laminated cell performs charging and discharging by transferring ions (for example, lithium ions) between the positive electrode and the negative electrode via the electrolyte. Each battery cell 12 is not limited to the laminated type, and may be a square or cylindrical type, and the electrolyte may be liquid or solid. In the following description, the four battery modules 11 may be collectively referred to as a battery 10.

Returning to FIG. 2, the battery case 20 includes a base plate 30 on which the battery 10 is placed, a frame member 40 constituting an outer frame of the battery case 20, and a cover 50 covering the battery 10.

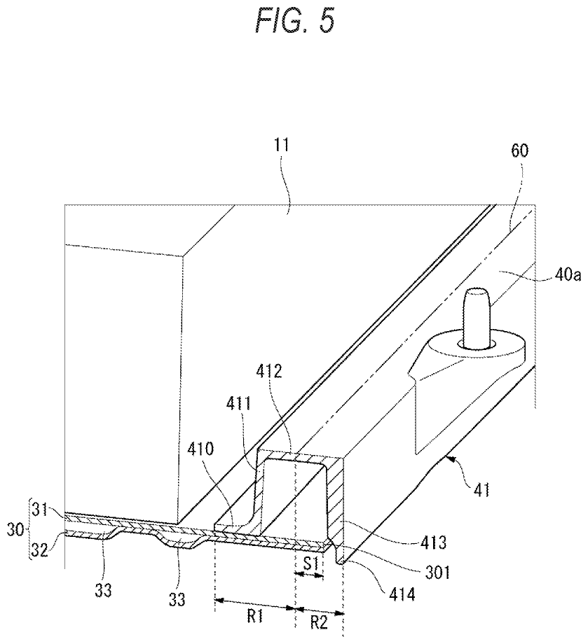

The base plate 30 is formed, for example, by pressing a metal material such as aluminum. The base plate 30 includes a bottom plate 31 on which the battery 10 is placed and a water jacket plate 32 provided below the bottom plate 31, and is implemented by two plates overlapping in an upper-lower direction. A water jacket 33 through which a refrigerant (for example, cooling water) for cooling the battery 10 flows is formed between the bottom plate 31 and the water jacket plate 32 (see FIG. 5). The base plate 30 may be constituted by only one (that is, only the bottom plate 31), or may be constituted by three or more.

A heat insulator 34 made of, for example, foamed polypropylene is attached to the base plate 30 from below, and covers the water jacket 33 from below. Further, a lower cover is attached to the base plate 30 from below the heat insulator 34.

The frame member 40 is joined to an outer edge of the base plate 30 and constitutes the outer frame (that is, a rear wall, a front wall, a left wall, and a right wall) of the battery case 20. In recent years, there is an increasing demand for a cast material as a sustainable material, and in the present embodiment, a cast material (for example, an aluminum cast material) is applied to the frame member 40. The frame member 40 includes a rear cross member 41 provided at a rear edge of the base plate 30, a front cross member 42 provided at a front edge of the base plate 30, and a pair of side frames 43 and 44 provided at left and right edges of the base plate 30. The rear cross member 41 and the front cross member 42 extend in the left-right direction, and the pair of side frames 43 and 44 extend in the front-rear direction. The rear cross member 41 and the front cross member 42 are connected to the pair of side frames 43 and 44 by welding or the like.

The rear cross member 41 and the front cross member 42 are each provided with fixing portions 47 for fixing the battery 10 to the base plate 30 and the frame member 40. The rear cross member 41, the front cross member 42, and the pair of side frames 43 and 44 are each provided with a fastening portion to be fastened to a vehicle body by a bolt or the like.

The frame member 40 further includes a central cross member 45 extending in the left-right direction and provided at a central portion of the base plate 30 in the front-rear direction. The central cross member 45 is disposed between the two battery modules 11 disposed on a front side and the two battery modules 11 disposed on a rear side. Similarly to the rear cross member 41 and the front cross member 42, the central cross member 45 is provided with fixing portions 47 to which the battery 10 is fixed. The central cross member 45 is connected to the pair of side frames 43 and 44 by welding or the like.

The cover 50 is attached to the frame member 40 via a sealing member 60. Although the cover 50 is not shown in FIG. 3, the sealing member 60 is provided between an upper surface 40a of the frame member 40 and an outer edge 51 of the cover 50. An interior of the battery case 20 is sealed by attaching the cover 50 to the upper surface 40a of the frame member 40 with the sealing member 60 interposed therebetween. The cover 50 is attached to the frame member 40 by, for example, a bolt. Here, in a state where the cover 50 is attached, a battery 10 side with respect to the sealing member 60 is defined as an inner side of the battery case 20, and a side opposite to the battery 10 with respect to the sealing member 60 is defined as an outer side of the battery case 20.

When a large load is input from the outer side of the battery case 20 to the battery pack 1 configured as described above, a load capacity of the frame member 40 constituting the outer frame of the battery case 20 is generally increased in order to reduce a deformation of the battery case 20. In order to provide a load capacity when the above cast material is applied to the frame member 40, the frame member 40 needs to be significantly thickened, which increases a weight of components of the battery pack 1. Therefore, in the present embodiment, not only the frame member 40 made of the cast material but also the base plate is utilized to provide the load capacity efficiently, without making the frame member 40 thick.

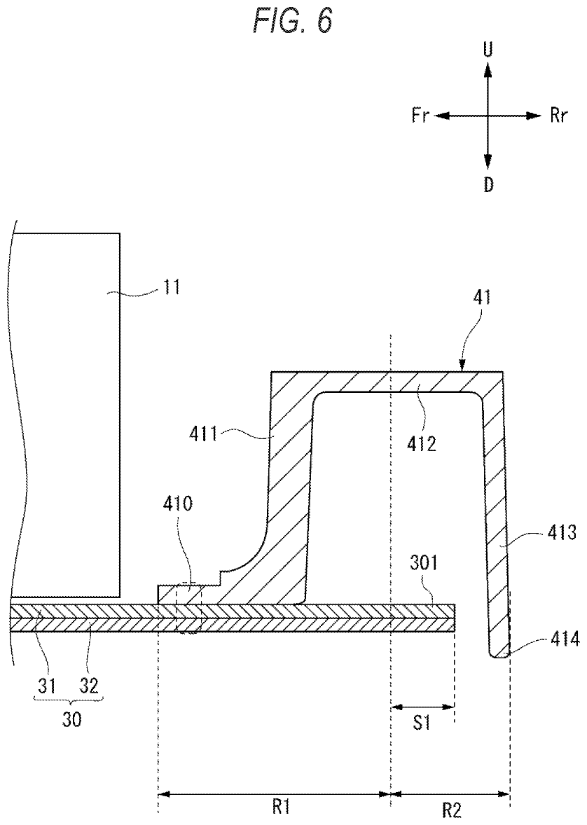

Hereinafter, configurations of the rear cross member 41 and the front cross member 42 and a configuration of the base plate 30 that can efficiently provide the load capacity when the large load is input to the battery pack 1 will be described in detail. First, the rear cross member 41 and a rear end 301 of the base plate 30 will be described with reference to FIGS. 5 and 6.

The rear cross member 41 includes a joint portion 410, an inner wall portion 411, an upper wall portion 412, and an outer wall portion 413. The joint portion 410 is a portion joined to an upper surface of the base plate 30. The rear cross member 41 and the base plate are joined by, for example, friction stir welding or welding. The inner wall portion 411 stands upward from the joint portion 410 and is located on the inner side of the battery case 20. The upper wall portion 412 extends in an outward direction of the battery case 20 from an upper end of the inner wall portion 411. The upper wall portion 412 constitutes the upper surface 40a of the frame member 40 and comes into contact with the sealing member 60 (indicated by a two-dot chain line in FIG. 5) when the cover 50 is attached. The outer wall portion 413 is provided on the outer side of the battery case 20 and extends downward from the upper wall portion 412. The inner wall portion 411, the upper wall portion 412, and the outer wall portion 413 form a shape in which a cross section taken along a plane orthogonal to a longitudinal direction (left-right direction) of the rear cross member 41 is open downward.

The rear cross member 41 has a protection region R1 located on an inner side with respect to the sealing member 60, that is, the inner side of the battery case 20, and a deformation region R2 located on an outer side with respect to the sealing member 60, that is, the outer side of the battery case 20.

The protection region R1 is a region to be protected without deformation from the viewpoint of protecting the battery 10 when the large load is input to the battery pack I due to a collision of the vehicle V or the like. The protection region R1 is constituted by the joint portion 410, the inner wall portion 411, and a portion of the upper wall portion 412 on the inner side with respect to the sealing member 60.

The deformation region R2 is a region in which a deformation is allowed when the large load is input to the battery pack 1. When the deformation region R2 is deformed by the load input from the outside, collision energy is absorbed in the deformation region R2. The deformation region R2 is constituted by a portion of the upper wall portion 412 on the outer side with respect to the sealing member 60 and the outer wall portion 413.

In the present embodiment, the base plate 30 is joined to the rear cross member 41 in the protection region R1, and the rear end 301 extends to the deformation region R2 when viewed in a cross section. According to such a configuration, when the vehicle V collides, before a load due to the collision is applied from the rear of the vehicle to the protection region R1, the rear end 301 of the base plate 30 receives the load. Accordingly, it is possible to prevent a deformation of the protection region R1 of the rear cross member 41, that is, a deformation of the inner side of the battery case 20. In addition, when a portion of the base plate 30 located in the deformation region R2 is deformed by the input load, the portion absorbs collision energy by deforming. That is, a crush stroke S1 of the base plate 30 is ensured. Further, since the deformation of the protection region R1 of the rear cross member 41 is prevented by using the base plate 30, it is not necessary to form the rear cross member 41 to be thick. Therefore, it is possible to protect the battery 10 against the load input due to the collision of the vehicle V while reducing a weight.

As described above, the base plate 30 is constituted by two plates overlapping in the upper-lower direction, that is, the bottom plate 31 and the water jacket plate 32. According to such a configuration, a proof stress of the base plate 30 is increased, and the deformation of the protection region R1 of the rear cross member 41 can be further prevented.

The rear end 301 of the base plate 30 is located on an inner side with respect to an outer edge (here, the outer wall portion 413) of the rear cross member 41. Accordingly, the base plate 30 is shortened, and a weight of the battery pack 1 can be reduced.

The rear cross member 41 has a lower end 414 located below the base plate 30 in the deformation region R2. The lower end 414 is a lower end of the outer wall portion 413. In other words, when viewed from the rear, the outer wall portion 413 of the rear cross member 41 overlaps the rear end 301 of the base plate 30. According to such a configuration, for example, when the vehicle V comes into contact with a curb or the like and receives a load from below, the deformation region R2 of the rear cross member 41 receives the load earlier than the base plate 30, and thus the base plate 30 can be protected, and consequently, the battery 10 can be protected. In the present embodiment, the rear end 301 of the base plate 30 and the outer wall portion 413 are spaced apart from each other, but may be in contact with each other.

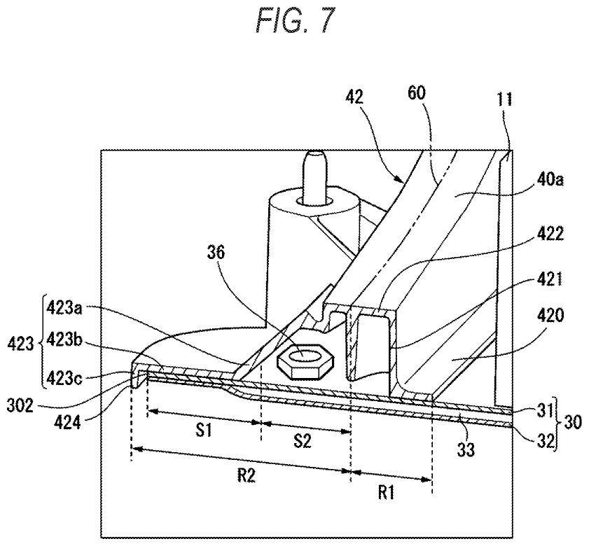

Next, the front cross member 42 and a front end 302 of the base plate 30 will be described with reference to FIG. 7.

Similarly to the rear cross member 41, the front cross member 42 includes a joint portion 420, an inner wall portion 421, an upper wall portion 422, and an outer wall portion 423. Similarly to the rear cross member 41, a protection region R1 of the front cross member 42 is constituted by the joint portion 420, the inner wall portion 421, and a portion of the upper wall portion 422 on an inner side with respect to the sealing member 60, and a deformation region R2 of the front cross member 42 is constituted by a portion of the upper wall portion 422 on an outer side with respect to the sealing member 60 and the outer wall portion 423.

The base plate 30 is joined to the front cross member 42 in the protection region R1, and the front end 302 extends to the deformation region R2 when viewed in a cross section, and thus when the vehicle V collides, before a load due to the collision is applied from the front of the vehicle to the protection region R1, the front end 302 of the base plate 30 receives the load. Accordingly, it is possible to prevent a deformation of the protection region R1 of the front cross member 42, that is, a deformation of the inner side of the battery case 20, and to protect the battery 10.

A weld nut 36 used for fastening the bottom plate 31 and the water jacket plate 32 is provided in a space surrounded by the base plate 30 and the front cross member 42. In the present embodiment, the weld nut 36 is provided in the deformation region R2. The weld nut 36 has a rigidity higher than that of the front cross member 42, and is an example of a rigid member of the present invention. The weld nut 36 is less likely to be deformed even when a large load is applied, and the region where the weld nut 36 is provided is a region that is not crushed, that is, a dead stroke region S2.

In the vicinity of the weld nut 36, the outer wall portion 423 of the front cross member 42 includes an inclined portion 423a extending while being inclined downward from the upper wall portion 422 to the upper surface of the base plate 30, a horizontal portion 423b extending horizontally along the upper surface of the base plate 30, and a vertical wall portion 423c extending downward from a tip end of the horizontal portion 423b. The weld nut 36 is disposed in a space surrounded by the upper wall portion 422, the inclined portion 423a, and the base plate 30.

Here, the front end 302 of the base plate 30 extends to an outer side with respect to the weld nut 36. According to such a configuration, when a portion of the base plate 30 located on the outer side with respect to the weld nut 36 is deformed by the input load, the portion absorbs collision energy by deforming. That is, even when the weld nut 36, which is a rigid member, is provided, the crush stroke S1 of the base plate 30 can be secured outside the protection region R1.

Even in the vicinity of the weld nut 36, similarly to the other portions, the front end 302 of the base plate 30 is located on an inner side with respect to an outer edge (here, the vertical wall portion 423c) of the front cross member 42. Accordingly, the base plate 30 is shortened, and a weight of the battery pack 1 can be reduced.

Further, the front cross member 42 has a lower end 424 located below the base plate in the deformation region R2. The lower end 424 is a lower end of the vertical wall portion 423c of the outer wall portion 423. In other words, when viewed from the rear, the front cross member 42 overlaps the front end 302 of the base plate 30. According to such a configuration, for example, when the vehicle V comes into contact with a curb or the like and receives a load from below, the deformation region R2 of the front cross member 42 receives the load earlier than the base plate 30, and thus the base plate 30 can be protected, and consequently, the battery 10 can be protected.

### <Modifications of Frame Member and Base Plate>

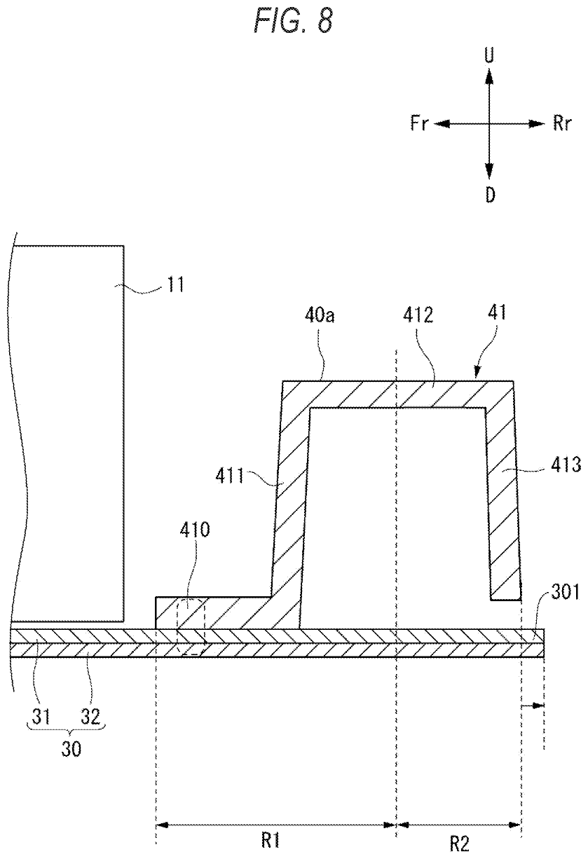

FIGS. 8 to 11 are views showing first to fourth modifications of the rear cross member 41 and the rear end 301 of the base plate 30, respectively. Members common to those of the above embodiment will be described using common reference numerals.

As shown in FIG. 8, in the first modification, unlike the above embodiment, the lower end of the outer wall portion 413 is located above the base plate 30, and the rear end 301 of the base plate 30 extends beyond the deformation region R2 of the rear cross member 41.

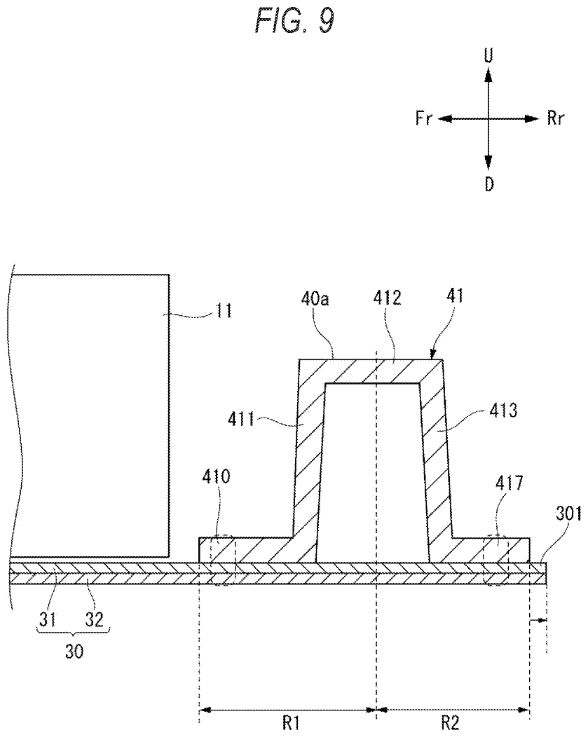

As shown in FIG. 9, in the second modification, the rear cross member 41 has a hat-shaped cross section. The rear cross member 41 of the second modification further includes a joint portion 417 that extends from the lower end of the outer wall portion 413 in the outward direction of the battery case 20 and is joined to the upper surface of the base plate 30. The rear end 301 of the base plate 30 extends beyond the deformation region R2 of the rear cross member 41.

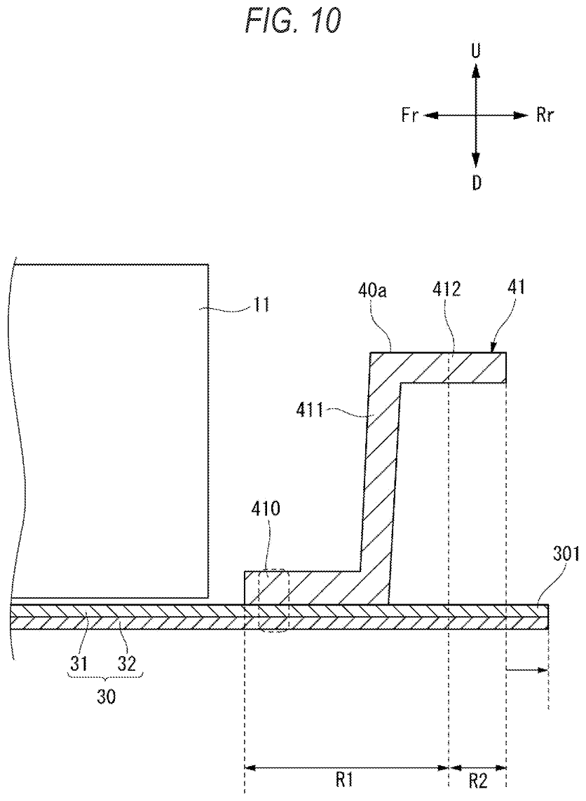

As shown in FIG. 10, in the third modification, the rear cross member 41 does not include the outer wall portion 413. The rear end 301 of the base plate 30 extends beyond the deformation region R2 of the rear cross member 41.

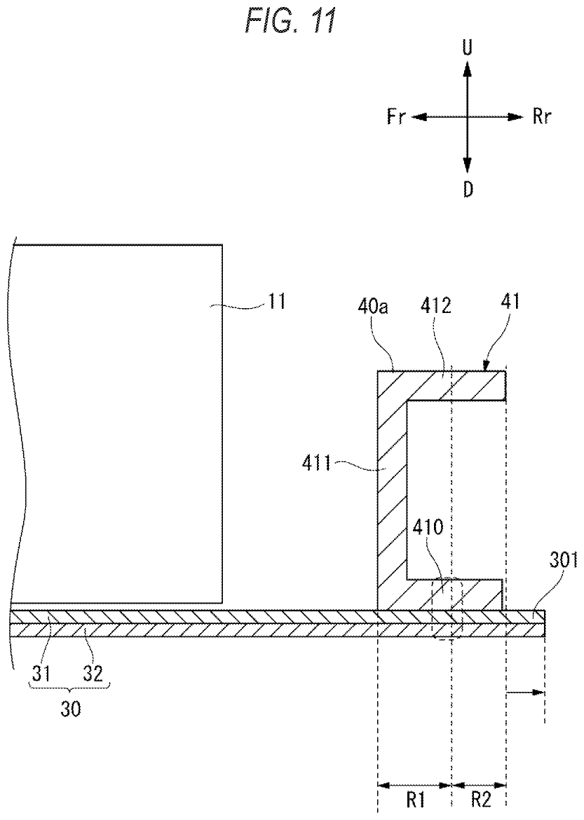

As shown in FIG. 11, in the fourth modification, the rear cross member 41 has a substantially U-shape opening to the outer side of the battery case 20. The rear cross member 41 of the fourth modification does not include the outer wall portion 413. The rear end 301 of the base plate 30 extends beyond the deformation region R2 of the rear cross member 41.

In the first to fourth modifications, the rear end 301 of the base plate 30 extends beyond the deformation region R2 of the rear cross member 41, that is, the rear end 301 of the base plate 30 is located on an outer side with respect to the rear cross member 41. With such a configuration, when a collision of the vehicle V occurs, the base plate 30 receives a load earlier than the rear cross member 41. Therefore, a deformation of the rear cross member 41 can be further prevented, and the battery 10 can be easily protected.

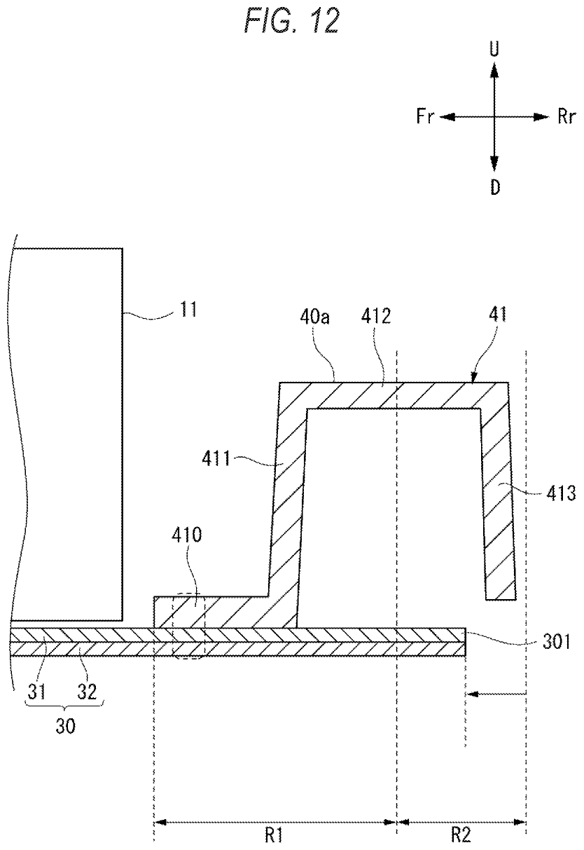

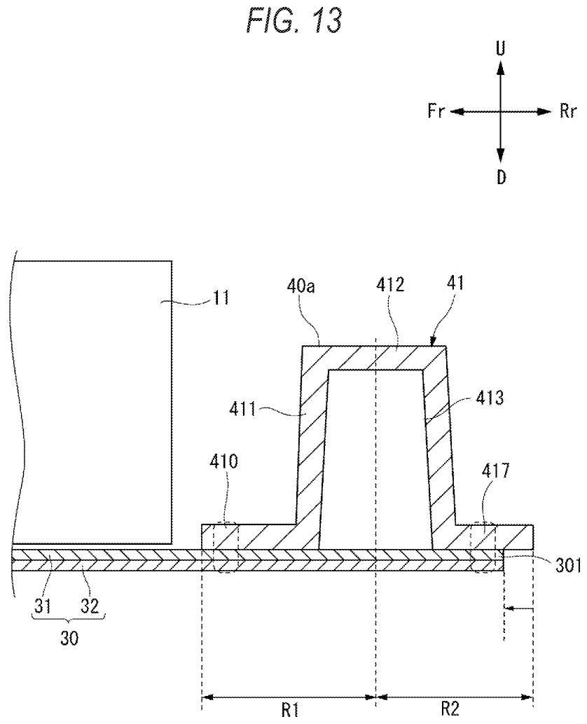

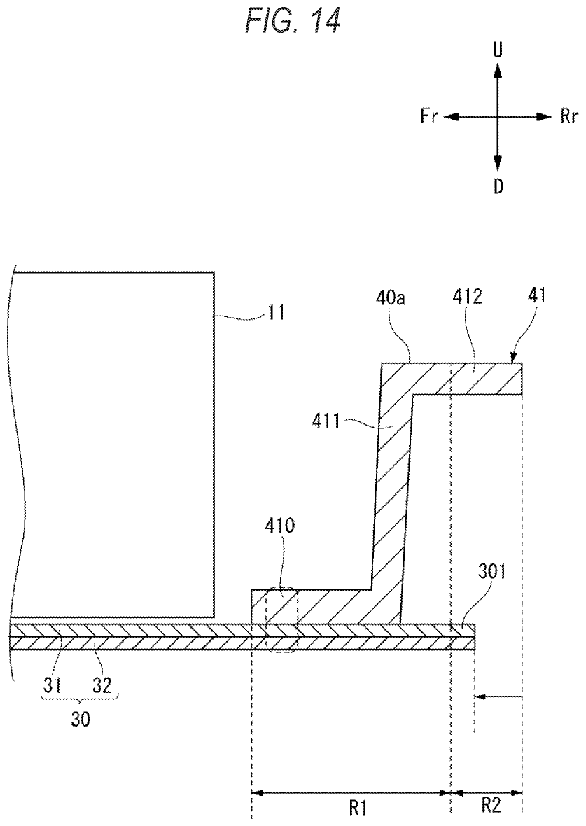

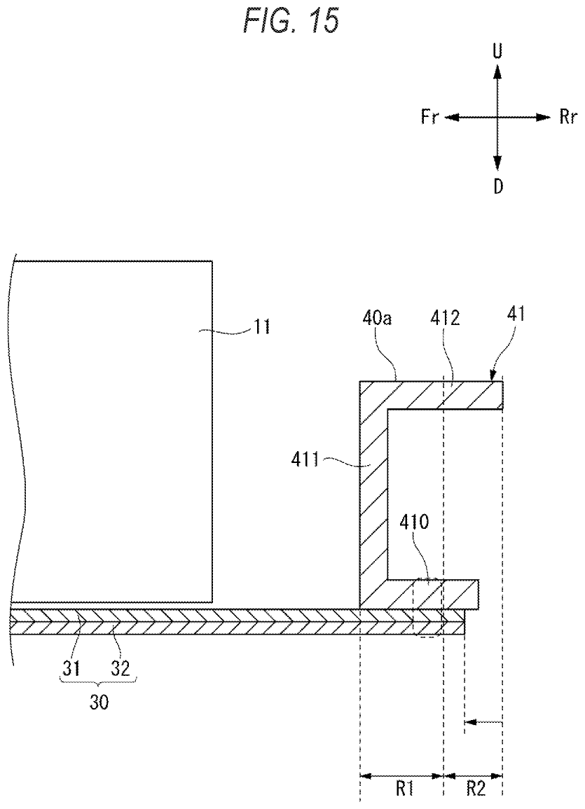

FIGS. 12 to 15 are views showing fifth to eighth modifications of the rear cross member 41 and the base plate 30, respectively. The rear cross members 41 of the fifth to eighth modifications have the same configuration as those of the first to fourth modifications described above, respectively, but configurations of the base plate 30 are different.

In the fifth to eighth modifications, the rear end 301 of the base plate 30 is located on the inner side with respect to the outer edge of the rear cross member 41. According to such a configuration, it is possible to reduce a weight of the base plate 30 or the rear cross member 41, and consequently, it is possible to reduce a weight of the battery pack 1.

Although the first to eighth modifications described above relate to the rear cross member 41 and the rear end 301 of the base plate 30, the first to eighth modifications can also be applied to the front cross member 42 and the front end 302 of the base plate 30.

Although an embodiment and modifications of the present disclosure have been described above with reference to the accompanying drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, the components in the above embodiment may be freely combined without departing from the gist of the invention.

In the above embodiment, the cast material is applied to the frame member 40, but the present invention is not limited thereto, and a material and a manufacturing method applied to the frame member 40 are any materials and manufacturing methods.

In the above embodiment, the weld nut 36 is provided in the deformation region R2, but may be provided in the protection region R1.

In the present description, at least the following matters are described. In parentheses, corresponding components and the like in the above embodiment are shown as an example, but the present invention is not limited thereto.

(1) A battery pack (battery pack 1) to be mounted on a vehicle (vehicle V), the battery pack including:
a battery (battery 10); and
a battery case (battery case 20) accommodating the battery,
in which the battery case includes:
   a base plate (base plate 30) on which the battery is placed;
   a frame member (rear cross member 41, front cross member 42) joined to an outer edge of the base plate; and
   a cover (cover 50) covering the battery and attached to the frame member via a sealing member (sealing member 60),
the frame member includes:
   a protection region (protection region R1) located on an inner side with respect to the sealing member; and
   a deformation region (deformation region R2) located on an outer side with respect to the sealing member, and
the base plate is joined to the frame member in the protection region, and a tip end (rear end 301, front end 302) of the base plate extends to at least the deformation region when viewed in a cross section.

According to (1), since the tip end of the base plate extends to at least the deformation region of the frame member, when a collision of the vehicle or the like occurs, the tip end of the base plate receives a load due to the collision before the load due to the collision is applied to the protection region. Therefore, a deformation of the protection region of the frame member, that is, an inner side of the battery case can be prevented. Since the deformation of the protection region of the frame member can be prevented by using the base plate, it is not necessary to form the frame member to be thick. Therefore, it is possible to protect the battery against a load input due to the collision of the vehicle or the like while reducing a weight.

(2) The battery pack according to (1),
in which the base plate includes a plurality of plates (bottom plate 31 and water jacket plate 32) overlapping in an upper-lower direction.

According to (2), since a proof stress of the base plate is increased, the deformation of the protection region of the frame member can be further prevented.

(3) The battery pack according to (1) or (2),
in which a rigid member (weld nut 36) having a rigidity higher than that of the frame member is provided in the protection region or the deformation region, and
the tip end of the base plate extends to an outer side with respect to the rigid member.

According to (3), even when the rigid member is disposed, since the tip end of the base plate extends to the outer side with respect to the rigid member, a crush stroke of the base plate can be ensured. That is, for a relatively small load, the base plate supports the load, and for a relatively large load, the base plate extending to the outer side with respect to the rigid member can absorb the load while deforming, so that movement of the rigid member which is difficult to absorb the load can be prevented, and the battery can be protected.

(4) The battery pack according to any one of (1) to (3),
in which the tip end of the base plate is located on an outer side with respect to the frame member.

According to (4), since the load input when the collision of the vehicle occurs is applied to the base plate earlier than the frame member, the battery is more easily protected.

(5) The battery pack according to any one of (1) to (3),
in which the tip end of the base plate is located on an inner side with respect to an outer edge of the frame member.

According to (5), the base plate can be shortened, and thus a weight of the battery pack can be reduced.

(6) The battery pack according to (5),
in which the frame member has a portion (lower ends 414 and 424) located below the base plate in the deformation region.

According to (6), for example, when the vehicle comes into contact with a curb or the like and receives a load from below, the deformation region of the frame member receives the load earlier than the base plate, and thus the base plate can be protected, and consequently, the battery can be protected.

What is claimed is:

1. A battery pack to be mounted on a vehicle, the battery pack comprising:
a battery; and
a battery case accommodating the battery,
wherein the battery case includes:
a base plate on which the battery is placed;
a frame member joined to an outer edge of the base plate; and
a cover covering the battery and attached to the frame member via a sealing member,
the frame member includes:
a protection region located on an inner side with respect to the sealing member; and
a deformation region located on an outer side with respect to the sealing member, and
the base plate is joined to the frame member in the protection region, and a tip end of the base plate extends to at least the deformation region when viewed in a cross section.

2. The battery pack according to claim 1,
wherein the base plate includes a plurality of plates overlapping in an upper-lower direction.

3. The battery pack according to claim 1,
wherein a rigid member having a rigidity higher than that of the frame member is provided in the protection region or the deformation region, and
the tip end of the base plate extends to an outer side with respect to the rigid member.

4. The battery pack according to claim 1,
wherein the tip end of the base plate is located on an outer side with respect to the frame member.

5. The battery pack according to claim 1,
wherein the tip end of the base plate is located on an inner side with respect to an outer edge of the frame member.

6. The battery pack according to claim 5,
wherein the frame member has a portion located below the base plate in the deformation region.
